(19) United States
(12) Patent Application Publication
(10) Pub. No.: US 2026/0056619 A1
(43) Pub. Date: Feb. 26, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KAZUKI HAMADA, Tokyo (JP)

(21) Appl. No.: 19/306,843

(22) Filed: Aug. 21, 2025

(30) Foreign Application Priority Data
Aug. 26, 2024 (JP) 2024-144138

(51) Int. Cl. G06F 3/01; G06V 10/764; G06V 40/10; G06V 40/20

(52) U.S. Cl. CPC G06F 3/017; G06V 10/764; G06V 40/11; G06V 40/28

(57) ABSTRACT

An information processing apparatus includes a processor and a memory storing a program which, when executed by the processor, causes the information processing apparatus to execute storage processing for storing information that is based on a first posture in the memory when a first hand included in a first captured image is in the first posture representing a specific gesture in the first captured image, and execute inference processing, when a specific part of a second hand is included in a second captured image that is captured after the first captured image, for inferring a posture of the second hand corresponding to the specific gesture, wherein the inference processing is performed based on the information and a posture of the specific part, even if the second hand included in the second captured image does not exhibit the specific gesture.

### BACKGROUND

### Field of the Technology

The present disclosure relates to an information processing apparatus that executes recognition of hand gestures.

### Description of the Related Art

As a technique for real-time fusion of the real world and computer-generated graphics (CG), there exist techniques known as Mixed Reality (MR) and Augmented Reality (AR). MR and AR can provide immersive experiences by presenting the user with a composite image of the real world and CG using a device called a head-mounted display (HMD), which is worn on the user's head, and enabling interaction between the user and the CG. One method of interaction with CG is hand gesture operation. Various sensors, such as cameras mounted on the head-mounted display, detect the user's hand. When the hand forms a predetermined gesture, CG is displayed in response, allowing the user to experience the illusion of grasping a virtual object. For example, Japanese Patent Laid-Open No. 2019-71048 describes a technique for recognizing hand gestures from a plurality of images including the user's hand.

### SUMMARY

In order to make it appear that a CG object is being grasped using a hand gesture, it is important to accurately align the orientation of the CG object with the actual orientation of the user's hand. However, depending on the orientation of the hand, certain parts, such as the fingertips, may not appear in the image used for hand gesture recognition, making it difficult to accurately calculate the orientation for grasping the CG object (hereinafter referred to as the “gesture posture”).

The present disclosure has been made in view of the above-described issues, and is directed to enabling the calculation of the gesture posture even in cases where it is difficult to calculate the gesture posture due to the orientation of the hand when a CG object is grasped using a hand gesture.

According to an aspect of the present disclosure, an information processing apparatus includes a processor and a memory storing a program which, when executed by the processor, causes the information processing apparatus to execute storage processing for storing information that is based on a first posture in the memory when a first hand included in a first captured image is in the first posture representing a specific gesture in the first captured image, and execute inference processing, when a specific part of a second hand is included in a second captured image that is captured after the first captured image, for inferring a posture of the second hand corresponding to the specific gesture, wherein the inference processing is performed based on the information and a posture of the specific part, even if the second hand included in the second captured image does not exhibit the specific gesture.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an information processing system according to a first embodiment.

FIG. 2 is a block diagram illustrating an internal configuration of a head-mounted display (HMD) according to the first embodiment.

FIG. 3A is a diagram illustrating a gesture posture in a pinch gesture as a hand gesture according to the first embodiment. FIG. 3B is a diagram illustrating an example of an object displayed in accordance with a gesture posture in the pinch gesture according to the first embodiment. FIG. 3C is a diagram illustrating a gesture posture in a grasp gesture as a hand gesture according to the first embodiment.

FIG. 4. is a flowchart illustrating processing for generating a display image by calculating a gesture posture according to the first embodiment.

FIGS. 5A and 5B are diagrams each illustrating a gesture posture and a reference posture according to the first embodiment.

FIG. 6 is a flowchart illustrating a method for calculating a gesture posture in a captured image by using a rotation angle from the orientation of a stored reference posture to the orientation of a reference posture detected from the captured image.

FIG. 7 is a flowchart illustrating a method for calculating a gesture posture in the captured image using the positional and orientational relationship between the stored reference posture and the stored gesture posture.

FIG. 8A is a diagram illustrating a scene of a captured image, which includes (captures) a hand representing a specific gesture according to the first embodiment. FIG. 8B is a diagram illustrating a reference posture and a gesture posture calculated in step S405 according to the first embodiment. FIG. 8C is a diagram illustrating a display image generated from a captured image in step S410 according to the first embodiment. FIG. 8D is a diagram illustrating a frame of a captured image, which includes (captures) a hand not representing a specific gesture according to the first embodiment. FIG. 8E is a diagram illustrating a reference posture in the captured image calculated in step S407 or S408 according to the first embodiment. FIG. 8F is a diagram illustrating a gesture posture calculated in step S408 according to the first embodiment. FIG. 8G is a diagram illustrating a display image generated by superimposing a virtual object rendered in step S409 on the captured image in step S410 according to the first embodiment.

### DESCRIPTION OF THE EMBODIMENTS

Hereinafter, embodiments are described with reference to the accompanying drawings. In the drawings, identical or equivalent components, elements, and processes are denoted by the same reference numerals, and redundant descriptions are omitted as appropriate. Additionally, in the drawings, portions of components, elements, and processes may be omitted for clarity.

### First Embodiment

### <System Configuration>

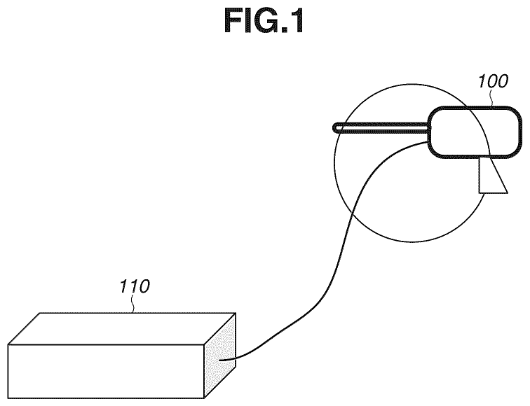

An information processing system 1 according to a first embodiment is described with reference to FIG. 1. The information processing system 1 includes a head-mounted display (HMD) 100 and a personal computer (PC) 110.

The HMD 100 is a head-mounted display apparatus (electronic device) which can be mounted on the user's head. The HMD 100 includes a camera for capturing images of an area in front of the user and a display for displaying the images to the user. The HMD 100 displays, on the display thereof, a composited image generated by compositing a captured image of an area in front of the user the HMD 100 has captured with content such as computer graphics (CG) generated in accordance with the posture of the HMD 100. This allows the user to experience virtual reality through their eyes. In the information processing system 1, the image captured by the HMD 100 is used to detect the user's hand, and information regarding the hand's position and orientation is obtained as the hand's posture. This enables the information processing system I to apply the user's hand movements to virtual objects, allowing the user to intuitively interact with virtual objects using their hands.

The PC 110 controls the HMD 100. The PC 110 is connected to the HMD 100 either via a wired connection using, for example, a universal serial bus (USB) cable or wirelessly through techniques, such as Bluetooth® or Wireless Fidelity (Wi-Fi) (registered trademark). The PC 100 and the HMD 101 can mutually transmit and receive images and other necessary information through wireless or wired communication. The PC 110 generates a composited image by compositing an image captured by the HMD 100 with CG generated by the PC 110, and transmits the composited image to the HMD 100. In the present embodiment, the PC 110 is described as an example of the information processing apparatus. However, the information processing apparatus is not limited to the PC 110. For example, the information processing apparatus may be a smartphone or a tablet terminal, and the HMD 100 may include the constituent elements of the PC 110.

### <Internal Configuration of HMD>

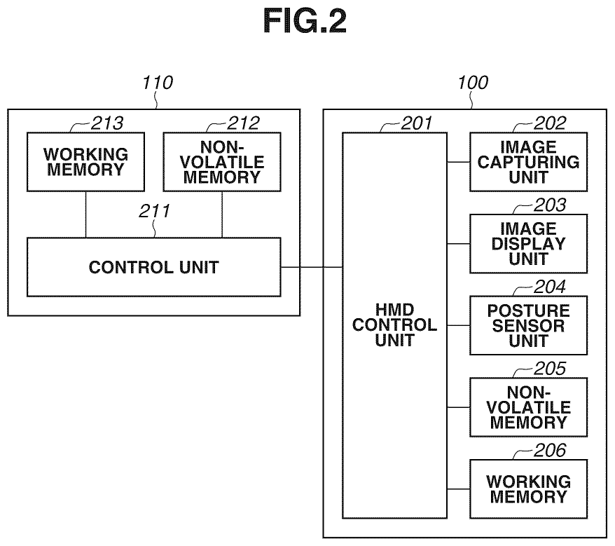

Internal configuration of the HMD 100 is described with reference to FIG. 2. The HMD 100 includes an HMD control unit 201, an image capturing unit 202, an image display unit 203, a posture sensor unit 204, a non-volatile memory 205, and a working memory 206.

The HMD control unit 201 controls the constituent elements of the HMD 100. The HMD control unit 201 includes at least one central processing unit (CPU) that executes a program stored in the non-volatile memory 205, and at least one circuit. The HMD control unit 201 acquires a composited image (i.e., an image generated by compositing a captured image of a space in front of the user captured by the image capturing unit 202 with CG) from the PC 110, and displays the composited image on the image display unit 203. Alternatively, instead of the HMD control unit 201 controlling the entire apparatus, the control of the entire apparatus may be performed by distributing the processing among a plurality of hardware devices.

The image capturing unit 202 includes two cameras (image capturing apparatuses). These two cameras are positioned in the proximity of the user's right and left eyes when the HMD 100 is mounted on the user's head. Thus, the two cameras can capture a space similar to the space seen by the user wearing the HMD 100. The images captured by the image capturing unit 202 are output to the HMD control unit 201, and the HMD control unit 201 transmits the images received from the image capturing unit 202 to the PC 110. As described below, the PC 110 generates a composited image by compositing a captured image transmitted from the HMD 100 with CG. The image capturing unit 202 simultaneously acquires a first image and a second image different from the first image, mutually having parallax, through the two cameras. Thus, information about a distance from the HMD 100 to an object (i.e., distance information) can be acquired by using the images captured by the two cameras included in the image capturing unit 202. The image capturing unit 202 may capture and output a moving image.

As described below, when the PC 110 transmits a composited image, the image display unit 203 displays the composited image transmitted from the PC 110. The image display unit 203 includes a display, such as a liquid crystal panel or an organic electro-luminescence (EL) panel. In a state where the user wears the HMD 100, a display, such as an organic EL panel, is positioned in front of each of the user's eyes. A device using a semi-transmissive half mirror can also be used for the image display unit 203. In such a case, for example, the image display unit 203 may display an image by directly superimposing CG on a real space the user can see through the half mirror through a technique generally called “AR”. Through a technique generally called “Virtual Reality (VR)”, the image display unit 203 may display an image of a complete virtual space without using a captured image.

The posture sensor unit 204 acquires information about the posture and position of the HMD 100. The posture sensor unit 204 acquires information about the posture of the user wearing the HMD 100 corresponding to the posture and position of the HMD 100. The posture sensor unit 204 includes an inertial measurement unit (IMU) including an acceleration sensor, an angular acceleration sensor, and a geomagnetic sensor. In a case where the user wears the HMD 100, the posture sensor unit 204 acquires information about a user's posture (i.e., posture information). The HMD control unit 201 outputs the information about a user's posture (posture information) detected by the posture sensor unit 204 to the PC 110.

The non-volatile memory 205 is an electrically erasable and recordable non-volatile memory, and a program executed by the HMD control unit 201 is stored in the non-volatile memory 205.

The working memory 206 is used as a buffer memory for temporarily storing image data captured by the image capturing unit 202, an image display memory for the image display unit 203, and a working area for the HMD control unit 201.

### <Internal Configuration of PC>

Internal configuration of the PC 110 is described with reference to FIG. 2. The PC 110 includes a control unit 211, a non-volatile memory 212, and a working memory 213.

The control unit 211 is a CPU including at least one processor or at least one circuit. The control unit 211 implements the processes illustrated in the below-described flowcharts by executing programs stored in the non-volatile memory 212. Instead of the control unit 211 controlling the entire apparatus, the control of the entire apparatus may be performed by distributing the processing among a plurality of hardware devices. The control unit 211 receives an image (captured image) acquired by the image capturing unit 202 and the posture information acquired by the posture sensor unit 204 from the HMD 100. The control unit 211 generates a composited image by compositing the captured image with optional CG based on the received information. The control unit 211 transmits the composited image to the HMD control unit 201 included in the HMD 100.

The non-volatile memory 212 is an electrically erasable and recordable non-volatile memory, and below-described programs executed by the control unit 211 and the information about CG are stored in the non-volatile memory 212. The control unit 211 can change CG (i.e., CG to be used to generate a composited image) to be read from the non-volatile memory 212.

The working memory 213 is a storage unit used as a working area of the control unit 211, such as a buffer memory, for temporarily storing image data captured by the image capturing unit 202.

### <Gesture Posture for Pinch Gesture>

The information processing system 1 of the present embodiment functions to composite a virtual object corresponding to a detected hand gesture with a captured image when the hand gesture is detected from the captured image received from the HMD 100.

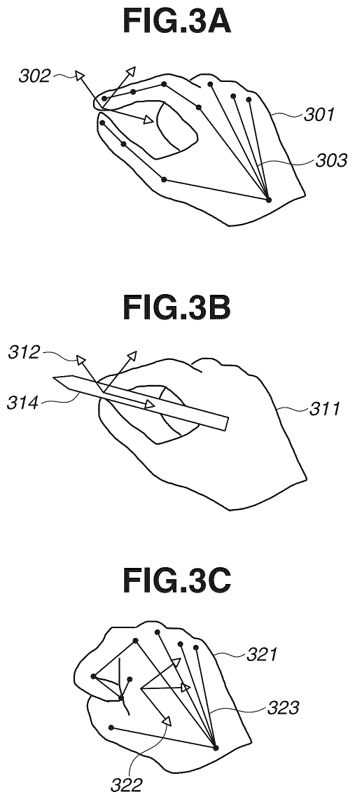

FIGS. 3A and 3B are diagrams illustrating a gesture posture for a pinch gesture described as a hand gesture according to the present embodiment.

FIG. 3A is a diagram illustrating a gesture posture for the pinch gesture.

A user's hand 301 has the forefinger and thumb touching, forming a shape as if pinching an object. Such a hand state is referred to as a pinch gesture. When a user's hand 311 is in a pinch gesture, it is assumed that the user is grasping an object between the touching forefinger and thumb. The orientation in which the object is grasped in this gesture is referred to as the gesture posture. A gesture posture 302 of the pinch gesture may be set, for example, in the direction indicated by arrows illustrated in FIG. 3A. Here, the arrows indicating the gesture posture 302 include three three-dimensional vectors orthogonal to one another.

The use of three-dimensional positions 303 of feature points of the user's hand 301 acquired by the control unit 211 enables determination as to whether the user's hand 301 is in a pinch gesture.

In this case, by calculating the distance between the feature points of fingertips of the forefinger and thumb among the three-dimensional positions 303 of the feature points, it is possible to determine that the user's hand is in a pinch gesture if the calculated distance is a predetermined threshold or less. Additionally, the use of image recognition technologies, such as machine learning, enables determination as to whether the user's hand 301 is in a pinch gesture. In this case, the control unit 211 can utilize an image recognition model that outputs information indicating whether a hand included in the image is in a pinch gesture. The image recognition model is created, for example, by being trained on images including hands forming a pinch gesture. Such an image recognition model can perform classification processing to determine whether the user's hand 301 is in a pinch gesture. As a method for determining whether the user's hand 301 is in a pinch gesture, the method using the three-dimensional positions 303 of the feature points of the user's hand 301 acquired by the control unit 211 and the method using an image recognition technique, such as machine learning, can be used in combination.

In a machine learning model, for example, a captured image is input into a convolutional neural network (CNN). The CNN outputs a feature amount to be used to identify a type of object and/or a type of image-captured scene. Using the feature amount output from the CNN, the type of object or image-captured scene can be identified. Examples of machine learning models used as detectors or classifiers for target objects or target individuals include YOLO, MobileNet, VGG16, and SSD.

A method using the three-dimensional positions 303 of feature points of a hand calculated by the control unit 211 can be considered as a method for acquiring a gesture posture 302 for the pinch gesture.

The gesture posture 302 can be acquired by calculating vectors from a plurality of feature points among the feature points of the three-dimensional positions 303 of the feature points. For example, the gesture posture 302 can be calculated from the feature points corresponding to a tip of the thumb, a base of the thumb, and a base of the forefinger.

Accurate calculation of the gesture posture 302 in accordance with the orientation of the hand enables display of the object in such a manner that the object appears to be naturally grasped without visual inconsistency, when the object is displayed in alignment with the direction of the pinch gesture posture 302.

FIG. 3B illustrates an example in which an object is displayed in accordance with the gesture posture of a pinch gesture.

An object 314 is a pen-shaped CG object (i.e., virtual object). When the user's hand 311 is in a pinch gesture, the pen-shaped object 314 is displayed along the vectors of the gesture posture 312. By displaying the object 314 in this manner, the user can feel as if they are actually pinching the object 314. In a case where the orientation of the user's hand 311 is changed, the gesture posture 312 and the posture of the object 314 are changed accordingly, enabling a more realistic experience.

### <Gesture Posture for Grasp Gesture>

FIG. 3C is a diagram illustrating a gesture posture in a grasp gesture described as a hand gesture according to the present embodiment.

The user's hand 321 is shaped as if grasping an object, with all fingers bent inward.

A gesture in which the hand is in such a posture is referred to as a grasp gesture. When the user's hand 321 is in a grasp gesture, it is assumed that the object is being held by wrapping the object with the entire fingers and palm. Thus, a gesture posture 322 of the grasp gesture may be set in a direction such as that illustrated in FIG. 3C. Here, the arrows indicating the gesture posture 322 include three three-dimensional vectors orthogonal to one another.

The use of three-dimensional positions 323 of feature points of the user's hand 321 acquired by the control unit 211 enables determination as to whether the user's hand 321 is performing the grasp gesture. In this case, the angle between two vectors is calculated by using a specific feature point of a specific finger serving as the origin and vectors extending to two adjacent feature points on the same finger, among the three-dimensional positions 323 of the feature points. If the angle between the two vectors falls below a predetermined threshold, it can be determined that the gesture is a grasp gesture. It is possible to determine whether the user's hand 321 is performing a grasp gesture by using an image recognition technique, such as machine learning. In this case, the control unit 211 can use an image recognition model that outputs information indicating whether a hand included in the image is in a grasp gesture. The image recognition model is, for example, created by being trained on images including hands forming a shape of a grasp gesture. Such an image recognition model can perform classification processing to determine whether the user's hand 321 is in a grasp gesture. As a method for determining whether the user's hand 321 is in a grasp gesture, the method using the three-dimensional positions 323 serving as feature points of the user's hand 321 acquired by the control unit 211 and the method using the image recognition technique, such as machine learning, can be used in combination.

A conceivable method for acquiring the gesture posture 322 includes a method using the three-dimensional positions 323 of feature points of the hand calculated by the control unit 211. The gesture posture 322 can be determined by calculating vectors from a plurality of feature points among the three-dimensional positions 323 serving as the feature points. For example, the gesture posture 322 can be calculated from positions of the feature points corresponding to the wrist, a base of the forefinger, a base of the middle finger, and a base of the little finger. Accurate calculation of the gesture posture 322 in accordance with the orientation of the hand enables display of the object in such a manner that the object appears to be naturally grasped without visual inconsistency, when the object is displayed in alignment with the direction of the gesture posture 322.

### <Method for Determining Gesture Posture and Reference Posture>

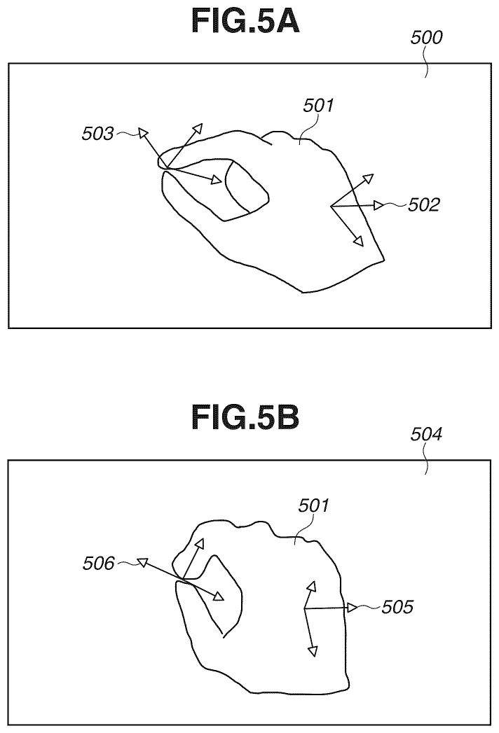

FIGS. 5A and 5B are diagrams each illustrating a gesture posture and a reference posture according to the present embodiment.

FIG. 5A illustrates a captured image 500 which is an image of one frame from a plurality of frames in a moving image captured by the image capturing unit 202. The captured image 500 includes a user's hand 501. The control unit 211 acquires three-dimensional positions of feature points of the user's hand 501 included in the captured image 500. Further, based on the acquired three-dimensional positions of the feature points, the control unit 211 calculates a reference posture 502 and a gesture posture 503 of the user's hand 501. The reference posture 502 can be calculated by using a posture of a part of the hand, such as a palm or a back. Even in a state where the fingers are hidden, the palm and the back of the hand can be detected with high reliability. The posture of the palm or the back of the hand can be calculated by using the feature points of a base of the forefinger, a base of the little finger, the wrist, and/or other parts. In FIG. 5A, a gesture posture of the pinch gesture is illustrated as the gesture posture 503. However, the gesture posture 503 can be a posture of other gestures, such as a grasp gesture. For example, gestures where two fingers are touching, or gestures where one or more fingers are extended, are also acceptable. Both the gesture posture and the reference posture may include information regarding position and orientation, or may include only orientation information.

A captured image 504 (which will be also referred to as second captured image 504) in FIG. 5B is an image of one frame in a moving image captured by the image capturing unit 202. The captured image 504 is a frame that appears later in time than the captured image 500. The user's hand 501 is included in the captured image 504, and the control unit 211 acquires three-dimensional positions of the feature points of the user's hand 501 included in the captured image 504. Based on the acquired three-dimensional positions of the feature points, the control unit 211 further calculates the reference posture 505 of the user's hand 501. Here, the reference posture 505 corresponds to the same part of the hand as that of the reference posture 502, and in this case, the posture of the palm or the back of the hand is used as the reference posture 502.

Based on the reference posture 502 and the gesture posture 503 calculated from the captured image 500 and the reference posture 505 calculated from the second captured image 504, a gesture posture 506 in the second captured image 504 is calculated. The below-described calculation method is used as a specific method for calculating the gesture posture 506 in the second captured image 504.

### <Flowchart Illustrating Processing for Generating Display Image by Acquiring Gesture Posture>

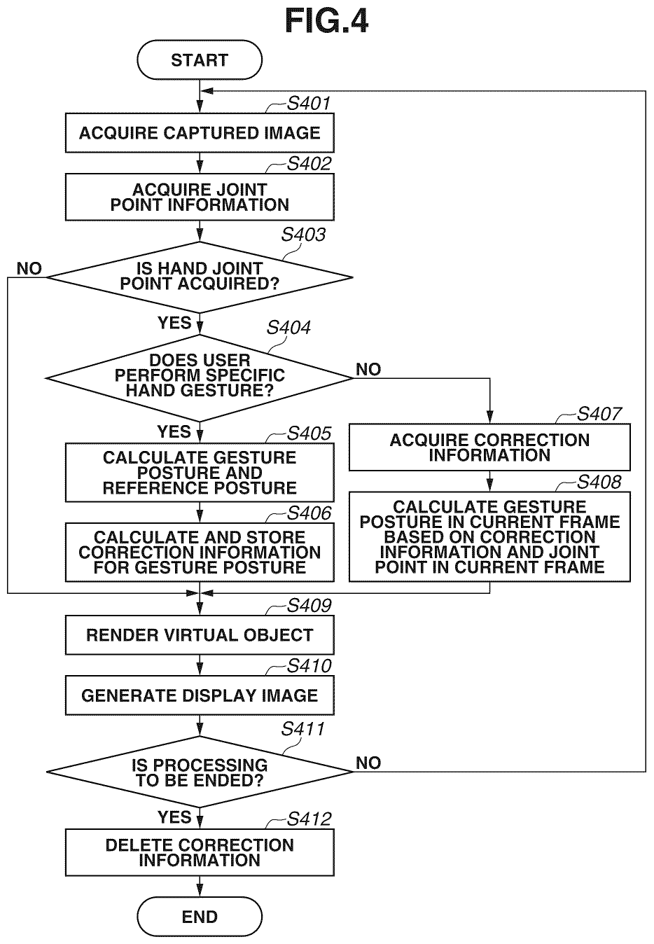

FIG. 4 is a flowchart illustrating a process of acquiring a gesture posture and generating a display image, according to the present embodiment. This process is implemented by the control unit 211 loading a program stored in the non-volatile memory 212 to the working memory 213 and executing the program. Timing for executing this flowchart is not limited to timing when a virtual object is displayed in a mixed-reality space. For example, the process of this flowchart may be executed at timing when the user activates the HMD 100 or timing when the user activates a predetermined application in the HMD 100. The predetermined application refers to an application that the user selects from a home screen (home space) after activating the HMD 100. An example of such an application is one that allows the user to interact with a virtual object by performing a hand gesture. The below-described processes may also be executed in a virtual space, in addition to the mixed-reality space. The process in FIG. 4 is executed every time one frame of a moving image is acquired from the image capturing unit 202. A description will be provided of a specific gesture of the user's hand, specifically, the pinch gesture illustrated in FIG. 4, is detected, and the case in which a virtual object corresponding to the pinch gesture is displayed, in the process illustrated in FIG. 4.

In step S401, the control unit 211 acquires a captured image captured by the image capturing unit 202. Then, the processing proceeds to step S402.

In step S402, based on the captured image acquired in step S401, the control unit 211 detects three-dimensional positions of feature points of the user's hand. Then, the processing proceeds to step S403. As described above, here, the operation in step S402 is executed on one frame of the moving image captured by the image capturing unit 202. As for the feature points of the user's hand, joint points are included, which are points inferred as the positions of at least one of the hand joints and fingertips. For example, 21 joint points may be acquired, including 20 points corresponding to the fingertips, first joints, second joints, and bases of each finger, and one point corresponding to the wrist.

In step S403, the control unit 211 determines whether the three-dimensional positions of the feature points (joint points) of the user's hand are detected. In a case where the control unit 211 determines that the three-dimensional positions of the feature points (joint points) of the user's hand are detected (YES in step S403), the processing proceeds to step S404. In a case where the control unit 211 determines that the three-dimensional positions of the feature points (joint points) of the user's hand are not detected (NO in step S403), the processing proceeds to step S409. For example, in a case where the hand is not captured in the captured image, three-dimensional positions of the feature points (joint points) of the user's hand cannot be detected. Thus, the processing proceeds to step S409.

In step S404, the control unit 211 determines whether the user's hand is performing the specific gesture. In a case where the control unit 211 determines that the user's hand is performing the specific gesture (YES in step S404), the processing proceeds to step S405. In a case where the control unit 211 determines that the user's hand is not performing the specific gesture (NO in step S404), the processing proceeds to step S407. In other words, in a case where the hand included in the captured image does not represent the specific gesture, specifically, the hand is in a gesture different from the specific gesture, the control unit 211 determines that the hand is not in the specific gesture. Thus the processing proceeds to step S407.

In step S405, the control unit 211 calculates a reference posture and a gesture posture in the captured image. Then, the processing proceeds to step S406.

In step S406, the control unit 211 calculates correction information for the gesture posture from the reference posture and the gesture posture in the captured image calculated in step S405, and stores the correction information in the working memory 213. Then, the processing proceeds to step S409. The control unit 211 may store the reference posture and the gesture posture in the working memory 213 without calculating the correction information, or may store only the gesture posture in the working memory 213. Here the correction information refers to, for example, information regarding the rotational difference and positional difference between the reference posture and the gesture posture in the captured image, calculated in Step S405. Using such differences along with the reference posture, it is possible to calculate (or infer) the gesture posture that could not be fully inferred from the image alone, by applying the method described below.

In step S407, the control unit 211 reads (acquires) the correction information from the working memory 213. Then, the processing proceeds to step S408. In step S407, in a case where the correction information cannot be acquired or is not stored in the working memory 213, the control unit 211 advances the processing to step S408 without acquiring the correction information. In a case where the correction information is stored in the working memory 213, the control unit 211 reads the correction information from the working memory 213. In a case where the reference posture and the gesture posture are stored in the working memory 213, the control unit 211 reads the reference posture and the gesture posture from the working memory 213, and calculates the correction information. In a case where the gesture posture is stored in the working memory 213 and the reference posture is not stored, the control unit 211 reads the gesture posture from the working memory 213, extracts the reference posture from the gesture posture, and calculates the correction information from the reference posture and the gesture posture. In a case where neither the reference posture nor the gesture posture is stored in the working memory 213, the control unit 211 advances the processing to step S408 without reading (acquiring) the correction information.

In step S408, based on the correction information acquired in step S407 and the reference posture, such as the posture of the palm or the back of the hand detected from the captured image, the control unit 211 calculates a gesture posture. A calculation method of the gesture posture executed in step S408 is described below. Even if the correction information is acquired in step S407, the control unit 211 detects the gesture posture without using the correction information in a case where the gesture posture can be detected from the captured image without using the correction information.

In step S409, the control unit 211 renders a virtual object. Then, the processing proceeds to step S410. Here, the virtual object is rendered in such a manner that the user appears to be holding the virtual object with their thumb and index finger through a pinch gesture, which is set to the specific gesture. Thus, based on the calculated gesture posture, the control unit 211 calculates the orientation of the virtual object simulated as if held by the user with a pinch gesture using their thumb and index finger.

The control unit 211 renders the virtual object in the calculated orientation. The virtual object is rendered in step S409 if there is any virtual object arranged in the mixed-reality space. The virtual object(s) arranged in the mixed-reality space is/are rendered in a case where the gesture posture is not yet calculated.

In step S410, the control unit 211 uses the virtual object rendered in step S409 and generates a display image to be displayed on the image display unit 203 of the HMD 100 (performs image generation processing). The processing then proceeds to step S411. After generating the display image, the control unit 211 may transmit the display image to the HMD 100 and execute display control processing of displaying the display image on the image display unit 203 of the HMD 100.

In step S411, the control unit 211 determines whether to end the processing. In a case where the control unit 211 determines to end the processing (YES in step S411), the processing proceeds to step S412. In a case where the control unit 211 determines not to end the processing (NO in step S411), the processing proceeds to step S401.

In step S412, the control unit 211 deletes the correction information if the correction information is stored in the working memory 213, and ends the processing. The control unit 211 may delete the correction information when the HMD 100 is turned off, and may be configured so as not to delete the correction information when a predetermined application is ended.

According to the above-described flowchart, for example, in a case where the captured image includes a hand with the thumb and index finger separated, the control unit 211 determines that the user's hand does not represent the specific gesture. The processing then proceeds to step S407. In step S407, the correction information is acquired if the correction information is stored. However, in step S408, the gesture posture is detected from the hand with the thumb and index finger separated, without using the correction information. Furthermore, if an image including a hand with the thumb and index finger separated is acquired after an image representing a specific gesture, the virtual object is rendered in such a manner that the virtual object appears not to have been moved. In other words, the virtual object is rendered to appear as if it remains in the same position as that at the time of rendering performed at the time of the acquisition of the image representing the specific gesture.

Here, when the correction information is calculated from the reference posture and gesture posture in the captured image in step S406 and stored in the working memory 213, the beneficial effect of reducing the computational load in step S407 is produced as compared with the case where the correction information is not stored.

In a case where real-time performance of the video is prioritized, the reference posture and gesture posture can be calculated from the captured image and the result can be stored in advance in the working memory 213.

In a case where the gesture posture in the captured image is stored without storing the reference posture in step S406, the reference posture is calculated from the stored gesture posture in step S407. In this manner, in a case where the gesture posture is stored in step S406, the correction information is not calculated, resulting in a reduced amount of data stored in the working memory 213, which is a beneficial effect, as compared with the case where both the gesture posture and the reference posture are stored. Thus, in a case where the amount of data in the working memory 213 is approaching its limit, the gesture posture in the captured image can be stored without storing the reference posture.

In the flowchart in FIG. 4, correction information is stored each time a specific gesture is detected. However, the storage timing is not limited thereto. Correction information may be stored only for the first frame in which the gesture is detected. In a case where a plurality of pieces of correction information is stored, the average of the plurality of pieces of correction information may be used to calculate the gesture posture in cases where part of the hand is occluded. Additionally, if the gesture is detected a plurality of times, the correction information may be overwritten and stored in the working memory 213 each time.

Correction information is acquired from a first frame in which a first gesture is detected and stored in the working memory 213, and correction information is not stored until the first gesture is ended. In a case where a second gesture is detected, correction information acquired from a first frame in which the second gesture is detected may be overwritten and stored in the working memory 213. In other words, correction information is acquired from a frame from which a series of gestures is firstly detected and stored in the working memory 213, and the correction information is used only for that series of gestures.

As described above, according to the flowchart in FIG. 4, a gesture posture in a captured image is calculated based on a plurality of image frames. In this way, a gesture posture can stably be acquired as compared with the case where the gesture posture is calculated based on information about only the second captured image.

<First Calculation Method for Gesture Posture with Reference Posture and Gesture Posture Stored>

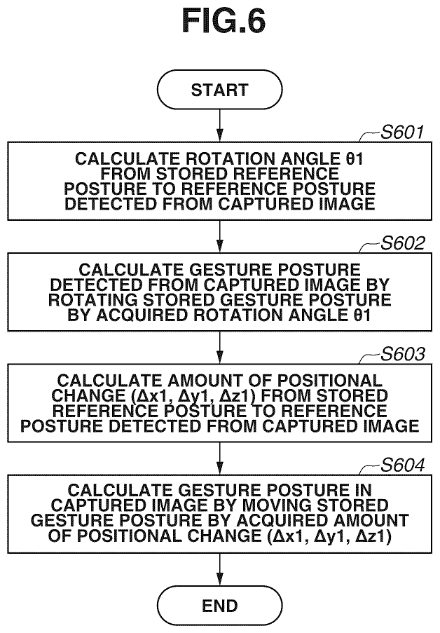

Referring to FIG. 6, a flowchart is described that illustrates a method for calculating a gesture posture using a rotation angle θ from the orientation of the stored reference posture to the orientation of the reference posture detected from the captured image. This process is executed, for example, in step S407 in FIG. 4, in a case where both the gesture posture and the reference posture have been stored in the working memory 213 in step S406.

In step S601, the control unit 211 calculates a rotation angle θ1, which represents the difference between the orientation of the reference posture stored in the working memory 213 and the orientation of the reference posture detected from the captured image. Then, the processing proceeds to step S602. Each reference posture orientation may be represented by a 3×3 rotation matrix or a quaternion, and the rotation angle θ1 may be calculated based on these representations.

In step S602, the control unit 211 calculates the orientation of the gesture posture in the captured image by rotating the gesture posture stored in the working memory 213 by the rotation angle θ1, acquired in step S601.

In step S603, the control unit 211 calculates the positional change (Δx1, Δy1, Δz1), which represents the difference between the position of the reference posture stored in the working memory 213 and the position of the reference posture detected from the captured image, and proceeds to step S604. Each reference posture and the positional change may be represented in a three-dimensional coordinate system or in a predefined two-dimensional coordinate system.

In step S604, the control unit 211 calculates the position of the gesture posture in the captured image by moving the gesture posture stored in the working memory 213 by the positional change (Δx1, Δy1, Δz1), obtained in step S603.

As described above, according to the flowchart in FIG. 6, a gesture posture can stably be acquired even in a case where the user's hand used for the calculation of the gesture posture is partially hidden.

<Second Calculation Method for Gesture Posture with Reference Posture and Gesture Posture Stored>

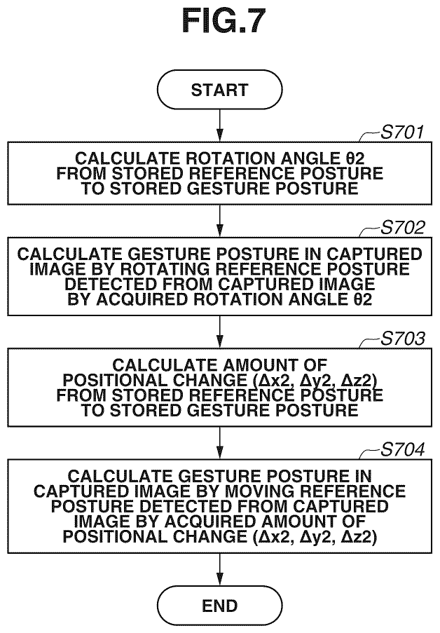

Referring to FIG. 7, a description will be provided of a flowchart that illustrates a method for calculating a gesture posture in the captured image using the positional and orientational relationship between the stored reference posture and the stored gesture posture. This process is executed, for example, in step S407 in FIG. 4, in a case where both the gesture posture and the reference posture have been stored in the working memory 213 in step S406. The processing corresponding to step S701 described below may be performed in step S406 in FIG. 4 to calculate correction information and store it in the working memory 213, and the processing corresponding to step S702 described below may be performed in step S407 in FIG. 4 to calculate the gesture posture.

In step S701, the control unit 211 calculates a rotation angle θ2, which represents the difference between the orientation of the reference posture stored in the working memory 213 and the orientation of the gesture posture stored in the working memory 213. Then, the processing proceeds to step S702. The orientation of the reference posture and the orientation of the gesture posture may be represented by a 3×3 rotation matrix or a quaternion, and the rotation angle θ2 may be calculated based on these representations. At this time, in a case where a plurality of combinations of reference postures and gesture postures is stored in the working memory 213, after the rotation angle from each reference posture to the corresponding gesture posture is calculated, the average thereof may be acquired and used.

In step S702, the control unit 211 calculates the orientation of the gesture posture in the captured image by rotating the reference posture in the captured image by the rotation angle θ2, obtained in step S701.

In step S703, the control unit 211 calculates the positional change (Δx2, Δy2, Δz2), which represents the difference between the position of the reference posture stored in the working memory 213 and the position of the gesture posture stored in the working memory 213. The processing then proceeds to step S704. Here, the reference posture, the gesture posture, and the positional change may be represented in a three-dimensional coordinate system or in a predefined two-dimensional coordinate system. At this time, in a case where a plurality of combinations of reference postures and gesture postures is stored in the working memory 213, after the positional change from the reference posture to the gesture posture is calculated, the average thereof may be acquired and used.

In step S704, the control unit 211 calculates a position of the gesture posture in the captured image by moving the reference posture in the captured image by the positional change (Δx2, Δy2, Δz2), acquired in step S703.

As described above, according to the flowchart in FIG. 7, a gesture posture can stably be acquired even in a case where the user's hand used for the calculation of the gesture posture is partially hidden.

### <Relationship Between Captured Image and Processing>

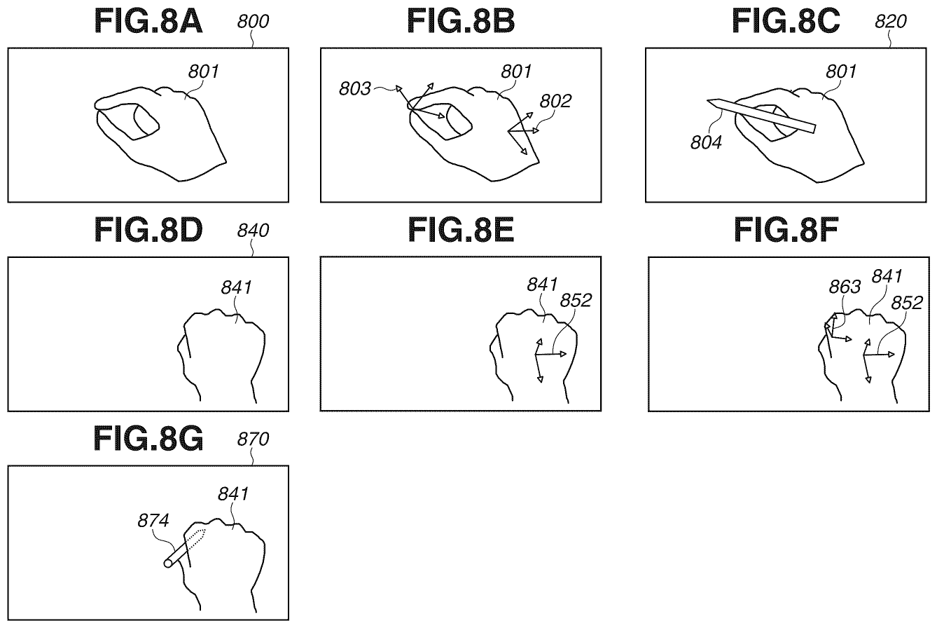

The relationship between the captured image acquired by the HMD 100 and the processing executed according to the flowchart in FIG. 4 is described with reference to FIGS. 8A, 8B, 8C, 8D, 8E, 8F, and 8G.

FIG. 8A is a diagram illustrating a scene of a captured image 800, which includes (captures) a hand 801 in a specific gesture. In step S401 in FIG. 4, in a case where an image such as the captured image 800 is acquired, the control unit 211 determines that the hand is in a specific gesture in step S404, and the processing proceeds to step S405.

FIG. 8B is a diagram illustrating a reference posture 802 and a gesture posture 803 calculated in step S405. In a case where the reference posture 802 and the gesture posture 803 are acquired, in step S406, the control unit 211 stores correction information acquired by calculating the difference between the gesture posture 803 and the reference posture 802 in the working memory 213.

FIG. 8C is a diagram illustrating a display image 820 generated from the captured image 800 in step S410. In the display image 820, the virtual object 804 rendered based on the gesture posture 803 in step S409 is superimposed.

FIG. 8D is a diagram illustrating a frame of a captured image 840, which includes (captures) a hand 841 not representing the specific gesture. The captured image 840 is assumed to be an image acquired after the captured image 800. In the captured image 840, it is actually assumed that the hand has changed its orientation while maintaining a shape similar to that of the hand 801 in the captured image 800. In other words, it is assumed that the user is still continuing the pinch gesture. However, in the captured image 840, the back of the hand 841 is visible, but the thumb and the forefinger are not. Therefore, the positions of the fingers cannot be confirmed from the captured image 840, and it is unclear whether all fingers are folded or if the hand is still in the pinch gesture as with the hand 801. Accordingly, in a case where the image such as the captured image 840 is acquired in step S401 in FIG. 4, the control unit 211 determines that the hand does not represent the specific gesture in step S404, and the processing proceeds to step S407.

FIG. 8E is a diagram illustrating a reference posture 852 in the captured image 840, calculated in step S407 or S408. The information about the image alone allows for an inference of the finger positions; however, whether the inference result is truly accurate cannot be confirmed.

FIG. 8F is a diagram illustrating a gesture posture 863 calculated in step S408. The gesture posture 863 is calculated from the correction information, which is calculated based on the captured image 800 and stored in the working memory 213, and the reference posture 852 acquired from the captured image 840. In a case where the captured image 840 is acquired, in step S409, the orientation of the virtual object to be displayed is calculated based on the gesture posture 863, and the virtual object is rendered.

FIG. 8G is a diagram illustrating a display image 870 generated by superimposing a virtual object 874 rendered in step S409 on the captured image 840 in step S410. The control unit 211 acquires information about depth of the hand 841 and represents the depth relationship between the virtual object 874 and the hand 841. Thus, it is assumed that a portion of the virtual object 874 hidden behind the hand 841 is not superimposed onto the captured image 840.

As described above, even after a specific gesture has been detected and the state of grasping a virtual object has been detected, if a part of the user's hand becomes occluded and no longer visibly represents the specific gesture, the control unit 211 estimates the posture (shape) of the specific gesture when a certain part of the hand is still visible. Based on the estimated posture (shape) of the specific gesture, the virtual object is rendered and a display image is generated, allowing the grasping state of the virtual object to be represented even when part of the hand is hidden. In other words, although the captured image 840 alone does not indicate a specific gesture (or does not allow determination of whether a specific gesture is indicated), the control unit 211 estimates the posture of the hand 841 assuming that the hand 841 is representing the specific gesture. In other words, it can be said that the posture of the hand 841 in the captured image 840 is estimated, under the premise that hand 841 is representing the specific gesture.

### OTHER EMBODIMENTS

The present disclosure can also be realized by executing the following processing. In other words, software (program) for realizing a function described in the above-described embodiment is supplied to a system or an apparatus via a network or various storage media, so that a computer (or a control unit or a micro processing unit (MPU)) of the system or the apparatus reads and executes the program code. In this case, the program and the storage medium storing that program constitute the present disclosure.

While the present disclosure has been described in detail with reference to the embodiments, it is to be understood that the present disclosure is not limited to the above-described specific embodiments, and many variations which do not depart from the essential spirit of the present disclosure should also be included within the scope of the present disclosure. Further, part of the above-described embodiments may be combined as appropriate.

Each of functional units described in the above-described embodiments (variation examples) may or may not be individual hardware. Functions of two or more functional units may be implemented by common hardware. Each of functions implemented by one functional unit may be implemented by individual hardware. Two or more functions implemented by one functional unit may be implemented by common hardware. Each of the functional units may or may not be implemented by hardware such as an application specific integrated circuit (ASIC), a field programmable gate array (FPGA), and a digital signal processor (DSP). For example, an apparatus may include a processor and a memory (storage medium) which stores a control program. Functions of at least part of functional units included in the apparatus may be implemented by a processor by reading a control program from a memory and executing the control program.

The present disclosure can also be realized through processing in which a program for implementing one or more functions according to the above-described embodiments is supplied to a system or an apparatus via a network or a storage medium, and one or more processors in the system or the apparatus read and execute the program. Further, the present disclosure can also be realized with a circuit, such as an ASIC, which implements one or more functions.

In the above-described embodiments, processors refer to processors in a broad sense, and the processors include general-purpose processors (e.g., CPU) and dedicated processors (e.g. a graphics processing unit (GPU), an ASIC, a FPGA, and a programmable logical device).

The present disclosure provides a technique that enables the calculation of a gesture posture even in cases where the orientation of the hand makes such calculation difficult when grasping a CG object using a hand gesture.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-144138, filed Aug. 26, 2024, which is hereby incorporated by reference herein in its entirety.

What is claimed is:

1. An information processing apparatus, comprising:
a processor; and
a memory storing a program which, when executed by the processor, causes the information processing apparatus to:
execute storage processing for storing information that is based on a first posture in the memory when a first hand included in a first captured image is in the first posture representing a specific gesture in the first captured image; and
execute inference processing, when a specific part of a second hand is included in a second captured image that is captured after the first captured image, for inferring a posture of the second hand corresponding to the specific gesture, wherein the inference processing is performed based on the information and a posture of the specific part, even if the second hand included in the second captured image does not exhibit the specific gesture.

2. The information processing apparatus according to claim 1,
wherein, in executing of the storage processing, the first posture is stored as the information, and
wherein, in executing of the inference processing, when the specific part of the second hand is included in the second captured image, the posture of the second hand representing the specific gesture is inferred based on the first posture and the posture of the specific part of the second hand even if the second hand does not represent the specific gesture in the second captured image.

3. The information processing apparatus according to claim 1,
wherein, in executing of the storage processing, a posture of the specific part of the first hand is further stored as the information, and
wherein, in executing of the inference processing, when the specific part of the second hand is included in the second captured image, the posture of the second hand representing the specific gesture is inferred based on the first posture, the posture of the specific part of the first hand, and the posture of the specific part of the second hand, even if the second hand does not represent the specific gesture in the second captured image.

4. The information processing apparatus according to claim 1,
wherein, in executing of the storage processing, differences in position and orientation between the first posture and the posture of the specific part of the first hand are stored as the information, and
wherein, in executing of the inference processing, when the specific part of the second hand is included in the second captured image, the posture of the second hand representing the specific gesture is inferred based on the differences and the posture of the specific part of the second hand, even if the second hand does not represent the specific gesture in the second captured image.

5. The information processing apparatus according to claim 1,
wherein the program, when executed by the processor, further causes the information processing apparatus to execute determination processing for determining whether a hand included in a captured image represents the specific gesture,
wherein, in executing of the storage processing, when it is determined that the first hand represents the specific gesture through the determination processing, the information is stored in the storage unit, and
wherein, in executing of the inference processing, when the specific part of the second hand is included in the second captured image, the posture of the second hand representing the specific gesture is inferred based on the information and the posture of the specific part, even if it is determined that the second hand does not represent the specific gesture through the determination processing due to a part of the second hand being hidden in the second captured image.

6. The information processing apparatus according to claim 5, wherein, in executing the determination processing, whether the hand represents the specific gesture is determined based on positions of a plurality of joint points each of which is a point inferred as a position of at least one of a hand joint and a fingertip.

7. The information processing apparatus according to claim 5, wherein, in executing the determination processing, classification is used to determine whether the hand represents the specific gesture.

8. The information processing apparatus according to claim 1,
wherein the program, when executed by the processor, further causes the information processing apparatus to execute detection processing for detecting positions of a plurality of joint points each of which is a point inferred as a position of at least one of a hand joint and a fingertip, from a captured image, and
wherein, in executing the storage processing, the information is stored in the storage unit based on the positions of the plurality of joint points each of which is the point inferred as the position of at least one of the hand joint and the fingertip.

9. The information processing apparatus according to claim 1, wherein the specific part is a part of a hand for which detection accuracy is high.

10. The information processing apparatus according to claim 1, wherein the specific gesture is either a pinch gesture, in which a thumb and an index finger are brought close together, or a grasp gesture, in which a hand is closed.

11. An information processing apparatus, comprising:
a processor; and
a memory storing a program which, when executed by the processor, causes the information processing apparatus to:
execute storage processing for storing information based on a first posture in the memory when a first hand included in a first captured image is in the first posture representing a specific gesture; and
execute display control processing to display a first image on a display when the first hand is in the first posture in the first captured image, the first image being generated by compositing a virtual object in an orientation corresponding to the first posture,
wherein, in executing the display control processing, control is performed to display a second image on the display when a specific part of a second hand is included in a second captured image that is captured after the first captured image, even if the second hand included in the second captured image does not represent the specific gesture, the second image being generated by compositing the virtual object in an orientation corresponding to a posture of the specific part.

12. The information processing apparatus according to claim 11,
wherein, in executing the storage processing, differences in position and orientation between the first posture and the posture of the specific part of the first hand are stored as the information, and
wherein, in executing the display control processing, control is performed to display the second image generated based on the differences and the posture of the specific part on the display unit.

13. The information processing apparatus according to claim 11, wherein the program, when executed by the processor, further causes the information processing apparatus to execute inference processing for inferring a posture of the second hand corresponding to the specific gesture, based on the information and the posture of the specific part in the second captured image.

14. The information processing apparatus according to claim 13, wherein the program, when executed by the processor, further causes the information processing apparatus to execute generation processing for generating a virtual object based on the posture of the second hand inferred through the inference processing.

15. The information processing apparatus according to claim 11, wherein the program, when executed by the processor, further causes the information processing apparatus to execute image generation processing for generating the first image by compositing the virtual object in the orientation corresponding to the first posture with the first captured image and generating the second image by compositing the virtual object in the orientation corresponding to the specific part with the second captured image.

16. A control method for an information processing apparatus, comprising:
storing information that is based on a first posture in a memory, when a first hand included in a first captured image is in the first posture representing a specific gesture in the first captured image; and
executing inference processing, when a specific part of a second hand is included in a second captured image that is captured after the first captured image, for inferring a posture of the second hand corresponding to the specific gesture, wherein the inference processing is performed based on the information and a posture of the specific part, even if the second hand included in the second captured image does not exhibit the specific gesture.

17. A non-transitory computer readable storage medium that stores a program, wherein the program causes a computer to execute a control method according to claim 16.

18. An information processing system, comprising:
a storage device configured to store information that is based on a first posture in a memory, when a first hand included in a first captured image is in the first posture representing a specific gesture in the first captured image; and
an inference device configured to execute inference processing, when a specific part of a second hand is included in a second captured image that is captured after the first captured image, for inferring a posture of the second hand corresponding to the specific gesture, wherein the inference processing is performed based on the information and a posture of the specific part, even if the second hand included in the second captured image does not exhibit the specific gesture.

19. A control method for an information processing apparatus, comprising:
executing storage processing for storing information based on a first posture in a memory, when a first hand included in a first captured image is in the first posture representing a specific gesture; and
executing display control processing to display a first image on a display when the first hand is in the first posture in the first captured image, the first image being generated by compositing a virtual object in an orientation corresponding to the first posture,
wherein, in executing the display control processing, control is performed to display a second image on the display when a specific part of a second hand is included in a second captured image that is captured after the first captured image, even if the second hand included in the second captured image does not represent the specific gesture, the second image being generated by compositing the virtual object in an orientation corresponding to a posture of the specific part.

20. An information processing system, comprising:
a display device;
a storage device configured to store information based on a first posture in a memory, when a first hand included in a first captured image is in the first posture representing a specific gesture; and
a display control device configured to perform control to display a first image on a display when the first hand is in the first posture in the first captured image, the first image being generated by compositing a virtual object in an orientation corresponding to the first posture,
wherein the display control device performs control to display a second image on the display when a specific part of a second hand is included in a second captured image that is captured after the first captured image, even if the second hand included in the second captured image does not represent the specific gesture, the second image being generated by compositing the virtual object in an orientation corresponding to a posture of the specific part.
